(19) United States
(12) Patent Application Publication
(10) Pub. No.: US 2026/0221995 A1
(43) Pub. Date: Jul. 30, 2026

(54) WIRELESS COMMUNICATION SYSTEM, WIRELESS COMMUNICATION DEVICE, WIRELESS COMMUNICATION METHOD AND SIGNAL COMPENSATION PROGRAM

(71) Applicants: NIPPON TELEGRAPH AND TELEPHONE CORPORATION, Tokyo (JP); NTT DOCOMO, INC., Tokyo (JP)

(72) Inventors: Keita KURIYAMA, Musashino-shi, Tokyo (JP); Hitoshi HASEGAWA, Musashino-shi, Tokyo (JP); Toshifumi MIYAGI, Musashino-shi, Tokyo (JP); Satoshi SUYAMA, Tokyo (JP); Takayuki YAMADA, Tokyo (JP)

(73) Assignees: NIPPON TELEGRAPH AND TELEPHONE CORPORATION, Tokyo (JP); NTT DOCOMO, INC., Tokyo (JP)

(21) Appl. No.: 19/143,401

(22) PCT Filed: Jan. 31, 2023
(86) PCT No.: PCT/JP2023/003091

§ 371 Date: Jun. 26, 2025

(51) Int. Cl. H04B 1/10; H04B 17/21; H04B 17/391

(52) U.S. Cl. CPC H04B 1/1027; H04B 17/21; H04B 17/3913

(57) ABSTRACT

A wireless communication system according to one embodiment is a wireless communication system for compensating a processing target signal that is analog-processed in a process for a reception apparatus to receive the signal transmitted by a transmission apparatus using a radio wave, to perform wireless communication, wherein the reception apparatus receives each of function models and weights transmitted, estimates a plurality of factors that reduce accuracy of performing analog processing of the processing target signal, by the function models, respectively, calculates weights of the plurality of factors relative to reduction in the accuracy of performing analog processing, compensates the processing target signal using each of the function models, calculates weights of the plurality of factors relative to residual errors remaining in the compensated signal, and implements compensation accompanied by machine learning for the processing target signal that has been compensated.

### TECHNICAL FIELD

The present invention relates to a wireless communication system, a wireless communication apparatus, a wireless communication method, and a signal compensation program.

### BACKGROUND ART

In the case of using, for example, quadrature modulation and demodulation in wireless communication, received quadrature components I and Q may become signals with different attenuations and phase rotations by being affected by respectively different interferences (IQ imbalance). When IQ imbalance occurs, the quality of the wireless communication deteriorates. Therefore, a technology for estimating the phenomenon and implementing compensation is required.

Not only for IQ imbalance but also for non-linear distortion in an amplifier, carrier frequency offset, phase noise, and the like, technologies for compensating a processing target signal that is analog-processed in a process for a reception apparatus to receive the signal transmitted by a transmission apparatus using a radio wave, to perform wireless communication have been proposed (see, for example, NPL 1).

As for the processing target signal that is analog-processed, a failure (a device failure) due to the analog device circuit of the wireless communication apparatus often occurs.

### CITATION LIST

### Non Patent Literature

[NPL 1] S. Fouladifard, H. Shafiee, “Frequency offset estimation in OFDM systems in presence of IQ imbalance,” ICCS, 2002, pp. 214-218

### SUMMARY OF THE INVENTION

### Problem to be Solved by the Invention

Conventionally, however, there has been a problem that compensation accuracy deteriorates if, when device failures occur complexly, each of the individual phenomena is estimated and compensated. That is, when device failures occur complexly, the quality of wireless communication may deteriorate due to residual errors.

The present invention has been made in view of the above problem, and an object is to provide a wireless communication system capable of, even if device failures occur complexly for a processing target signal that is analog-processed in a process for a reception apparatus to receive the signal transmitted by a transmission apparatus using a radio wave, accurately compensating the processing target signal, a wireless communication apparatus, a wireless communication method, and a signal compensation

### Solution to Problem

A wireless communication system according to one embodiment of the present invention is a wireless communication system for compensating a processing target signal that is analog-processed in a process for a reception apparatus to receive the signal transmitted by a transmission apparatus using a radio wave, to perform wireless communication, wherein the transmission apparatus comprises: a first calculation unit estimating a plurality of factors that reduce accuracy of performing analog processing of the processing target signal, by function models, respectively, and calculating weights of the plurality of factors relative to reduction in the accuracy of performing analog processing; and a transmission analog processing unit performing processing for transmitting each of the function models and the weights estimated by the first calculation unit, and the reception apparatus comprises: a reception analog processing unit receiving each of the function models and the weights transmitted by the transmission analog processing unit; a second calculation unit estimating the plurality of factors that reduce the accuracy of performing analog processing of the processing target signal, by the function models, respectively, and calculating weights of the plurality of factors relative to the reduction in the accuracy of performing analog processing; a second compensation unit compensating, based on each of the function models and the weights received by the reception analog processing unit, and the weights calculated by the second calculation unit, the processing target signal using each of the function models; a third calculation unit calculating weights of the plurality of factors relative to residual errors remaining in the signal compensated by the second compensation unit; and a third compensation unit implementing compensation accompanied by machine learning, for the processed signal compensated by the second compensation unit based on the weights calculated by the third calculation unit.

A wireless communication apparatus according to one embodiment of the present invention is a wireless communication apparatus for compensating a processing target signal that is analog-processed in a process for performing transmission and reception using a radio wave, to perform wireless communication, the wireless communication apparatus comprising: a reception analog processing unit receiving a plurality of function models corresponding to a plurality of factors that reduce accuracy of performing analog processing of the processing target signal, the plurality of factors being estimated by a first calculation unit that another wireless communication apparatus comprises, and weights of the plurality of factors relative to reduction in the accuracy of performing analog processing; a second calculation unit estimating the plurality of factors that reduce the accuracy of performing analog processing of the processing target signal, by the function models, respectively, and calculating weights of the plurality of factors relative to the reduction in the accuracy of performing analog processing; a second compensation unit compensating, based on each of the function models and the weights received by the reception analog processing unit, and the weights calculated by the second calculation unit, the processing target signal using each of the function models; a third calculation unit calculating weights of the plurality of factors relative to residual errors remaining in the signal compensated by the second compensation unit; and a third compensation unit implementing compensation accompanied by machine learning, for the processing target signal compensated by the second compensation unit based on the weights calculated by the third calculation unit.

A wireless communication method according to one embodiment of the present invention is a wireless communication method for compensating a processing target signal that is analog-processed in a process for a reception apparatus to receive the signal transmitted by a transmission apparatus using a radio wave, to perform wireless communication, wherein the transmission apparatus performs: a first calculation step of estimating a plurality of factors that reduce accuracy of performing analog processing of the processing target signal, by function models, respectively, and calculating weights of the plurality of factors relative to reduction in the accuracy of performing analog processing; and a transmission analog processing step of performing processing for transmitting each of the function models and the weights estimated by the first calculation step, and the reception apparatus performs: a reception analog processing step of receiving each of the function models and the weights transmitted by the transmission analog processing step; a second calculation step of estimating the plurality of factors that reduce the accuracy of performing analog processing of the processing target signal, by the function models, respectively, and calculating weights of the plurality of factors relative to the reduction in the accuracy of performing analog processing; a second compensation step of compensating, based on each of the function models and the weights received by the reception analog processing step, and the weights calculated by the second calculation step, the processing target signal using each of the function models; a third calculation step of calculating weights of the plurality of factors relative to residual errors remaining in the signal compensated by the second compensation step; and a third compensation step of implementing compensation accompanied by machine learning, for the processing target signal compensated by the second compensation step based on the weights calculated by the third calculation step.

### Advantageous Effects of the Invention

According to the present invention, it is possible to, even if device failures occur complexly for a processing target signal that is analog-processed in a process for a reception apparatus to receive the signal transmitted by a transmission apparatus using a radio wave, accurately compensate the processing target signal.

### BRIEF DESCRIPTION OF DRAWINGS

FIG. 1 is a diagram showing a configuration overview of the wireless communication system.

FIG. 2 is a diagram schematically illustrating a configuration of a wireless communication system for compensating a plurality of device failures as a comparative example, the configuration including a compensation model.

FIG. 3 is a diagram schematically illustrating a configuration of a wireless communication system for compensating a plurality of device failures according to one embodiment, the configuration including a compensation model.

FIG. 4 is a flowchart showing the operation example of the wireless communication system according to the one embodiment.

FIG. 5 is a diagram showing a configuration overview of the other form of the wireless communication system according to the one embodiment.

FIG. 6 is a diagram schematically illustrating a configuration of the reproduction relay station, the configuration including a compensation model.

FIG. 7 is a diagram schematically illustrating a configuration of the reception apparatus, the configuration including a compensation model.

FIG. 8 is a diagram showing a hardware configuration example of the reception apparatus according to the one embodiment.

### DESCRIPTION OF EMBODIMENT

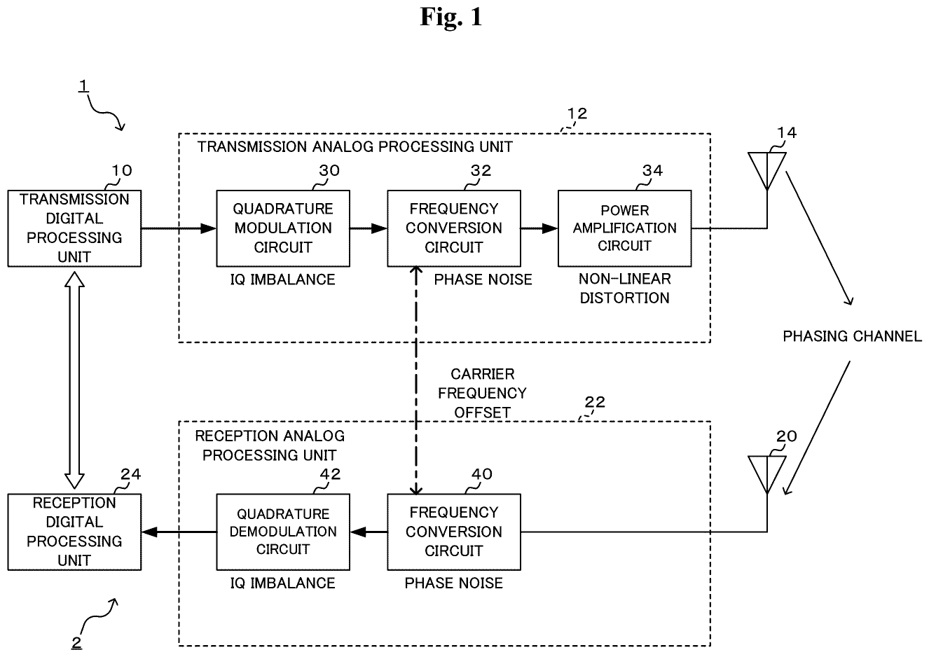

A configuration of a wireless communication system and a configuration for compensating the quality of wireless communication will be described below, using drawings. FIG. 1 is a diagram showing a configuration overview of the wireless communication system.

As shown in FIG. 1, the wireless communication system is configured, for example, so that a radio wave transmitted by a transmission apparatus (a transmission station) 1 is received by a reception apparatus (a reception station) 2. The wireless communication system compensates a processing target signal that is analog-processed in a process for the reception apparatus 2 to receive the signal transmitted by the transmission apparatus 1 using a radio wave, to perform wireless communication.

The transmission apparatus 1 includes a transmission digital processing unit 10, a transmission analog processing unit 12, and an antenna 14. The transmission digital processing unit 10 executes digital processing for transmitting a signal. The transmission analog processing unit 12 executes analog processing for transmitting the signal, and transmits the signal via the antenna 14.

The transmission analog processing unit 12 includes, for example, a quadrature modulation circuit 30, a frequency conversion circuit 32, and a power amplification circuit 34.

In the quadrature modulation circuit 30, a device failure of IQ imbalance may occur. In the frequency conversion circuit 32, a device failure of phase noise may occur. In the power amplification circuit 34, a device failure of non-linear distortion may occur.

The reception apparatus 2 includes an antenna 20, a reception analog processing unit 22, and a reception digital processing unit 24. The reception analog processing unit 22 receives a signal via the antenna 20 and performs analog processing and the like, for example, for enabling the signal to be demodulated. The reception digital processing unit 24 executes digital processing for the signal received by the reception analog processing unit 22.

The reception analog processing unit 22 includes, for example, a frequency conversion circuit 40 and a quadrature demodulation circuit 42. In the frequency conversion circuit 40, a device failure of phase noise may occur. In the quadrature demodulation circuit 42, a device failure of IQ imbalance may occur.

There is a phasing channel when the reception apparatus 2 receives a signal transmitted by the transmission apparatus 1. Furthermore, between the frequency conversion circuit 32 and the frequency conversion circuit 40, carrier frequency offset may occur.

Therefore, at least either one of the transmission digital processing unit 10 and the reception digital processing unit 24 estimates device failures according to phenomena, respectively, and executes compensation for the device failures that may occur complexly.

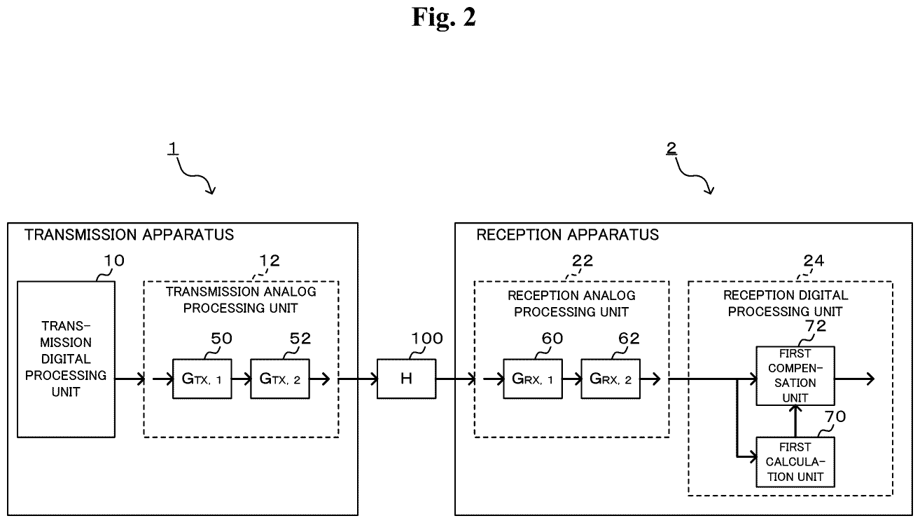

FIG. 2 is a diagram schematically illustrating a configuration of a wireless communication system for compensating a plurality of device failures as a comparative example, the configuration including a compensation model. Hereinafter, components that are substantially the same as those described above are given the same reference signs.

In the wireless communication system illustrated in FIG. 2, since one-to-one wireless communication is executed, for which compensation is executed by the reception apparatus 2, the number of function models of device failures that may occur in the transmission apparatus 1 and the reception apparatus 2 is assumed to be two.

Here, G indicates device failures of each analog device, which is expressed as a function model. Furthermore, H 100 indicates a transfer function of a phasing channel between the transmission apparatus 1 and the reception apparatus 2.

Specifically, a function model (G_{TX,1}) 50 and a function model (G_{TX,2}) 52 are set for the transmission analog processing unit 12. Furthermore, a function model (G_{RX, 1}) 60 and a function model (G_{RX,2}) 62 are set for the reception analog processing unit 22.

The reception digital processing unit 24 includes a first calculation unit 70 and a first compensation unit 72.

The first calculation unit 70 estimates a plurality of factors that reduce the accuracy of performing analog processing of a processing target signal, by the function models (the function model 50, the function model 52, H 100, the function model 60, and the function model 62), respectively, and calculates weights of the plurality of factors relative to reduction in the accuracy of performing analog processing (compensation weights).

The first compensation unit 72 compensates a processing target signal that is analog-processed, using the function models (the function model 50, the function model 52, H 100, the function model 60, and the function model 62) based on the weights calculated by the first calculation unit 70, respectively.

At this time, when device failures occur complexly, the accuracy of estimating each of the functions of the function models may deteriorate. Accordingly, appropriate compensation weights cannot be calculated, and deterioration of wireless communication quality due to residual errors may occur.

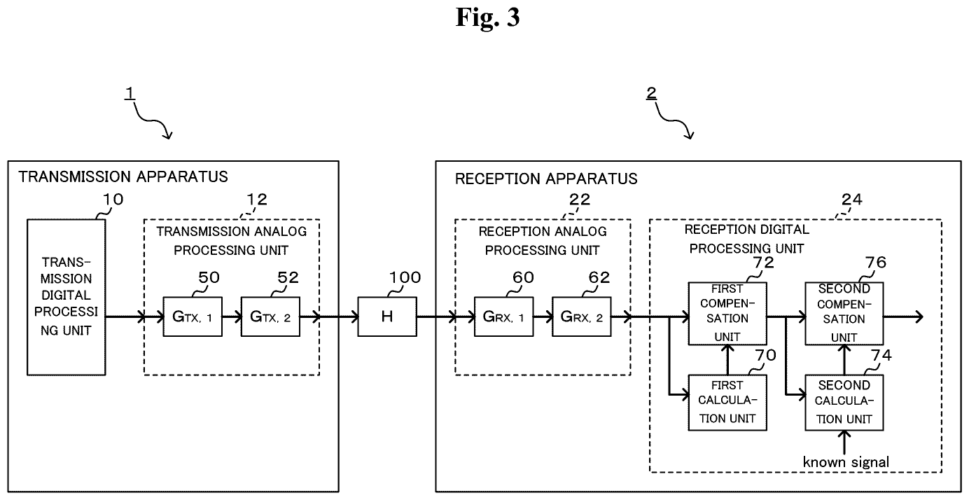

FIG. 3 is a diagram schematically illustrating a configuration of a wireless communication system for compensating a plurality of device failures according to one embodiment, the configuration including a compensation model. In the wireless communication system illustrated in FIG. 3, the reception digital processing unit 24 includes a second calculation unit 74 and a second compensation unit 76 in addition to the first calculation unit 70 and the first compensation unit 72 described above.

The second calculation unit 74 calculates weights of a plurality of factors relative to residual errors remaining in a signal compensated by the first compensation unit 72 (compensation weights).

The second compensation unit 76 implements compensation accompanied by machine learning, for the processing target signal compensated by the first compensation unit 72, based on the weights calculated by the second calculation unit 74 and a known signal. For example, the second compensation unit 76 implements compensation accompanied by machine learning for the processing target signal by at least any one of linear compensation, compensation by a neural network, and non-linear compensation using a non-linear activation function. Note that, as for an algorithm of non-linear compensation executed by the second compensation unit 76, an arbitrary algorithm can be used.

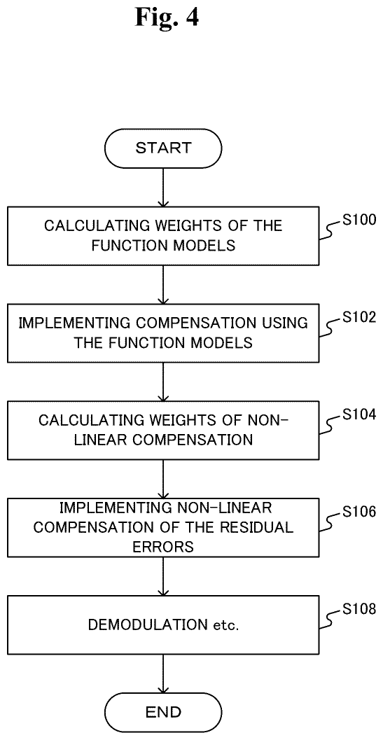

Next, an operation example of the wireless communication system according to the one embodiment will be described. FIG. 4 is a flowchart showing the operation example of the wireless communication system according to the one embodiment.

As shown in FIG. 4, at step 100 (S100), the wireless communication system calculates weights of the function models.

At step 102 (S102), the wireless communication system implements compensation using the function models.

At step 104 (S104), the wireless communication system calculates weights of non-linear compensation. For example, the wireless communication system learns weights for non-linear compensation weights so that residual errors are minimized, based on a result of compensation using the function models, estimated values of the function models, and a known signal.

At step 106 (S106), the wireless communication system implements non-linear compensation of the residual errors. For example, the wireless communication system implements the residual errors compensation based on the result of the compensation using the function models, and the non-linear compensation weights.

At step 108 (S108), the wireless communication system executes digital processing such as demodulation.

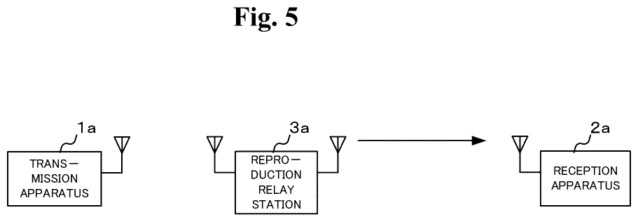

Next, another form of the wireless communication system will be described. FIG. 5 is a diagram showing a configuration overview of the other form of the wireless communication system according to the one embodiment. As shown in FIG. 5, in the other form of the wireless communication system, a configuration is made in which, for example, in order that a reception apparatus (a reception station) 2a receives a radio wave transmitted by a transmission apparatus (a transmission station) 1a, for example, a one-stage reproduction relay station (a relay station) 3a relays the radio wave. The wireless communication system compensates a processing target signal that is analog-processed in a process for the reception apparatus 2a to receive the signal transmitted by the transmission apparatus la using a radio wave, to perform wireless communication.

Note that the reproduction relay station 3a has a function as a transmission apparatus and a function as a reception apparatus, and relays a signal transmitted by the transmission apparatus la to the reception apparatus 2a.

Furthermore, the wireless communication system transmits models of device failures estimated by the transmission apparatus la or the reproduction relay station 3a and a transfer function of a channel to the reproduction relay station 3a or the reception apparatus 2a to be the subsequent stage, as auxiliary information (sub information). The reproduction relay station 3a or the reception apparatus 2a, which is the subsequent stage, is configured to execute non-linear compensation using the models of device failures and the transfer function of the channel that have been transmitted. Further, the transmission apparatus la or the reproduction relay station 3a may be configured to, in the case of implementing advance compensation before transmission of a signal, accept feedback of the auxiliary information.

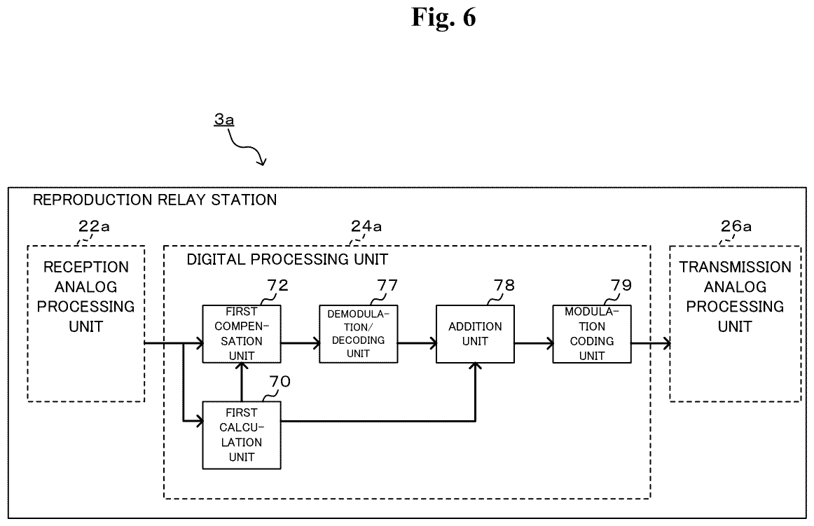

FIG. 6 is a diagram schematically illustrating a configuration of the reproduction relay station 3a, the configuration including a compensation model. The reproduction relay station 3a illustrated in FIG. 6 includes a reception analog processing unit 22a, a digital processing unit 24a, and a transmission analog processing unit 26a.

The reception analog processing unit 22a receives, for example, a signal transmitted by the transmission apparatus 1a and, for example, performs analog processing and the like for enabling the signal to be demodulated. The digital processing unit 24a executes digital processing for the signal received by the reception analog processing unit 22a. The transmission analog processing unit 26a performs analog processing to transmit the signal that has been digital-processed by the reception analog processing unit 22a, for example, to the reception apparatus 2a. For example, the transmission analog processing unit 26a performs processing for transmitting each of function models and weights estimated by the first calculation unit 70.

The reception analog processing unit 22a included in the reproduction relay station 3a receives, for example, each of the function models and the weights transmitted by the transmission apparatus 1a.

The digital processing unit 24a includes, for example, the first calculation unit 70, the first compensation unit 72, a demodulation/decoding unit 77, an addition unit 78, and a modulation coding unit 79.

The demodulation/decoding unit 77 demodulates/decodes a signal compensated by the first compensation unit 72. The addition unit 78 adds the function models (the function model 50, the function model 52, H 100, the function model 60, and the function model 62) and the weights (the compensation weights) estimated by the first calculation unit 70 to the signal demodulated/decoded by the demodulation/decoding unit 77 and outputs the signal. The modulation coding unit 79 performs modulation coding of the signal outputted by the addition unit 78.

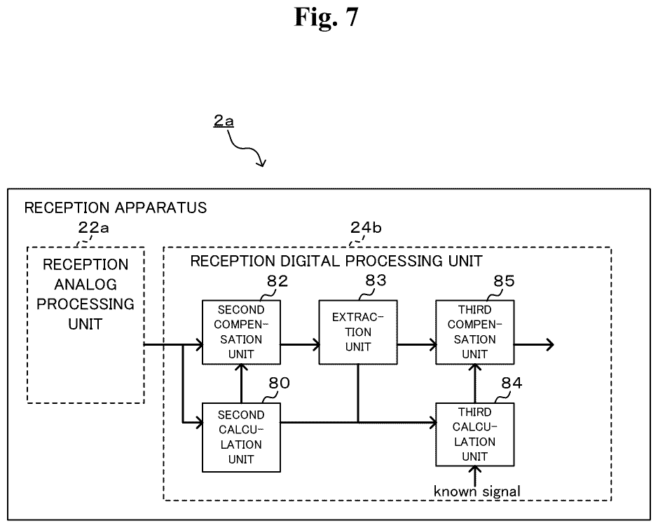

FIG. 7 is a diagram schematically illustrating a configuration of the reception apparatus 2a, the configuration including a compensation model. The reception apparatus 2a illustrated in FIG. 7 includes the reception analog processing unit 22a and a reception digital processing unit 24b.

The reception digital processing unit 24b includes a second calculation unit 80, a second compensation unit 82, an extraction unit 83, a third calculation unit 84, and a third compensation unit 85.

The second calculation unit 80 estimates a plurality of factors that reduce the accuracy of performing analog processing of a processing target signal, by the function models, respectively, and calculates and outputs weights of the plurality of factors relative to the reduction in the accuracy of performing analog processing.

Based on each of the function models and the weights received by the reception analog processing unit 22a and the weights calculated by the second calculation unit 80, the second compensation unit 82 compensates and outputs the processing target signal using each of the function models.

The extraction unit 83 extracts the auxiliary information described above from the signal outputted by the second compensation unit 82 and outputs the auxiliary information to the third calculation unit 84 and the third compensation unit 85.

The third calculation unit 84 calculates weights of a plurality of factors relative to residual errors remaining in the signal compensated by the second compensation unit 82, for example, using the information outputted by the second calculation unit 80 and the extraction unit 83.

The third compensation unit 85 implements compensation accompanied by machine learning, for the processing target signal compensated by the second compensation unit 82, based on the weights calculated by the third calculation unit 84.

For example, the third compensation unit 85 implements the compensation accompanied by machine learning for the processing target signal by at least any one of linear compensation, compensation by a neural network, and non-linear compensation using a non-linear activation function.

Note that the wireless communication system according to the one embodiment performs estimation of device failures and compensation using a plurality of function models. Furthermore, whether or not to use function models, the number of function models, and the like for the wireless communication system may be arbitrary.

Furthermore, the configuration of the wireless communication system according to the one embodiment is not limited to a particular form with regard to the number of systems for one-to-one communication, one-to-many communication, multi-hop communication via a relay station (including reproduction relay/non-reproduction relay), or the like, the antenna configuration such as SIMO, MIMO, or the like, signal characteristics such as single-carrier/multi-carrier transmission, and the like.

Furthermore, in the wireless communication system according to the one embodiment, processing for non-linear compensation may be performed by any wireless communication apparatus such as a transmission station, a reception station, a relay station, and the like, and the number of wireless communication apparatuses is also not limited. Furthermore, as for the form of transmission of sub information, the method is not limited, and any of a sub-carrier, exclusive packets/slots, power multiplexing, MIMO multiplexing, frequency multiplexing, and the like may be employed.

Thus, since the wireless communication system according to the one embodiment implements compensation accompanied by machine learning even for residual errors remaining in a compensated signal, it is possible to, even if device failures occur complexly for a processing target signal that is analog-processed in a process for a reception apparatus to receive the signal transmitted by a transmission apparatus using a radio wave, accurately compensate the processing target signal.

Note that “the first” to “the third” attached to the calculation units and the compensation units merely indicate that the units are different components in one wireless communication system.

Furthermore, as for the functions of each of the transmission apparatus 1 and the reception apparatuses 2 and 2a, a part or all of the functions may be configured with hardware such as a PLD (Programmable Logic Device) or an FPGA (Field Programmable Gate Array), or may be configured as a program to be executed by a processor such as a CPU.

For example, each of the reception apparatuses 2 and 2a can be realized with a computer and a program, and the program can be recorded in a storage medium or provided via a network.

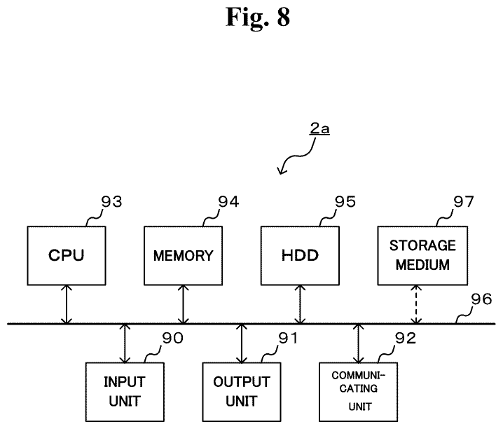

FIG. 8 is a diagram showing a hardware configuration example of the reception apparatus 2a according to the one embodiment. As shown in FIG. 8, in the reception apparatus 2a, an input unit 90, an output unit 91, a communication unit 92, a CPU 93, a memory 94, and an HDD 95 are connected via a bus 96, and the reception apparatus 2a has functions as a computer. Furthermore, the reception apparatus 2 is configured so as to be capable of inputting and outputting data to and from a computer-readable storage medium 97.

The input unit 90 is, for example, a keyboard, a mouse, and the like. The output unit 91 is, for example, a display device such as a display.

The communication unit 92 is a communication interface for performing wireless communication.

The CPU 93 controls each of the units constituting the reception apparatus 2a and performs predetermined processing and the like. The memory 94 and the HDD 95 are storage devices for storing data and the like.

The storage medium 97 is configured to be capable of storing programs and the like for causing the functions of the reception apparatus 2a to be executed. Note that the architecture constituting the reception apparatus 2a is not limited to the example shown in FIG. 5.

### REFERENCE SIGNS LIST

1,1a Transmission apparatus
2,2a Reception apparatus
3a Reproduction relay station
10 Transmission digital processing unit
12 Transmission analog processing unit
14 Antenna
20 Antenna
22,22a Reception analog processing unit
24,24b Reception digital processing unit
24a Digital processing unit
26a Transmission analog processing unit
30 Quadrature modulation circuit
32 Frequency conversion circuit
34 Power amplification circuit
40 Frequency conversion circuit
42 Quadrature demodulation circuit
50,52,60,62 Function model
70 First calculation unit
72 First compensation unit
74 Second calculation unit
76 Second compensation unit
77 Demodulation/decoding unit
78 Addition unit
79 Modulation coding unit
80 Second calculation unit
82 Second compensation unit
83 Extraction unit
84 Third calculation unit
85 Third compensation unit
90 Input unit
91 Output unit
92 Communication unit
93 CPU
94 Memory
95 HDD
96 Bus
97 Computer-readable storage medium
100 H (transfer function)

1. A wireless communication system for compensating a processing target signal that is analog-processed in a process for a reception apparatus to receive the signal transmitted by a transmission apparatus using a radio wave, to perform wireless communication, wherein
the transmission apparatus comprises:
first calculation circuitry configured to estimate a plurality of factors that reduce accuracy of performing analog processing of the processing target signal, by function models, respectively, and calculating weights of the plurality of factors relative to reduction in the accuracy of performing analog processing; and
transmission analog processing circuitry configured to perform processing for transmitting each of the function models and the weights estimated by the first calculation circuitry, and
the reception apparatus comprises:
reception analog processing circuitry configured to receive each of the function models and the weights transmitted by the transmission analog processing circuitry;
second calculation circuitry configured to estimate the plurality of factors that reduce the accuracy of performing analog processing of the processing target signal, by the function models, respectively, and calculating weights of the plurality of factors relative to the reduction in the accuracy of performing analog processing;
second compensation circuitry configured to compensate, based on each of the function models and the weights received by the reception analog processing circuitry, and the weights calculated by the second calculation circuitry, the processing target signal using each of the function models;
third calculation circuitry configured to calculate weights of the plurality of factors relative to residual errors remaining in the signal compensated by the second compensation circuitry; and
third compensation circuitry configured to implement compensation accompanied by machine learning, for the processed signal compensated by the second compensation circuitry based on the weights calculated by the third calculation circuitry.

2. The wireless communication system according to claim 1, wherein the third compensation circuitry implements the compensation accompanied by machine learning for the processing target signal by at least any one of linear compensation, compensation by a neural network, and non-linear compensation using a non-linear activation function.

3. A wireless communication apparatus for compensating a processing target signal that is analog-processed in a process for performing transmission and reception using a radio wave, to perform wireless communication, the wireless communication apparatus comprising:
reception analog processing circuitry configured to receive a plurality of function models corresponding to a plurality of factors that reduce accuracy of performing analog processing of the processing target signal, the plurality of factors being estimated by a first calculation circuitry that another wireless communication apparatus comprises, and weights of the plurality of factors relative to reduction in the accuracy of performing analog processing;
second calculation circuitry configured to estimate the plurality of factors that reduce the accuracy of performing analog processing of the processing target signal, by the function models, respectively, and calculating weights of the plurality of factors relative to the reduction in the accuracy of performing analog processing;
second compensation circuitry configured to compensate, based on each of the function models and the weights received by the reception analog processing circuitry, and the weights calculated by the second calculation circuitry, the processing target signal using each of the function models;
a third calculation circuitry configured to calculating weights of the plurality of factors relative to residual errors remaining in the signal compensated by the second compensation circuitry; and
third compensation circuitry configured to implement compensation accompanied by machine learning, for the processing target signal compensated by the second compensation circuitry based on the weights calculated by the third calculation circuitry.

4. The wireless communication apparatus according to claim 3, wherein the third compensation circuitry implements the compensation accompanied by machine learning for the processing target signal by at least any one of linear compensation, compensation by a neural network, and non-linear compensation using a non-linear activation function.

5. A wireless communication method for compensating a processing target signal that is analog-processed in a process for a reception apparatus to receive the signal transmitted by a transmission apparatus using a radio wave, to perform wireless communication, wherein
the transmission apparatus performs:
first estimating a plurality of factors that reduce accuracy of performing analog processing of the processing target signal, by function models, respectively, and first calculating weights of the plurality of factors relative to reduction in the accuracy of performing analog processing; and
transmission analog processing for transmitting each of the function models and the weights estimated by the first calculating, and
the reception apparatus performs:
receiving each of the function models and the weights transmitted by the transmission analog processing;
second estimating the plurality of factors that reduce the accuracy of performing analog processing of the processing target signal, by the function models, respectively, and second calculating weights of the plurality of factors relative to the reduction in the accuracy of performing analog processing;
second compensating, based on each of the function models and the weights received by the receiving, and the weights calculated by the second calculating, the processing target signal using each of the function models;
third calculating weights of the plurality of factors relative to residual errors remaining in the signal compensated by the second compensating; and
implementing compensation accompanied by machine learning, for the processing target signal compensated by the second compensating based on the weights calculated by the third calculating.

6. The wireless communication method according to claim 5, wherein, at the implementing, the compensation accompanied by machine learning is implemented for the processing target signal by at least any one of linear compensation, compensation by a neural network, and non-linear compensation using a non-linear activation function.

7. A non-transitory computer-readable storage medium storing a signal compensation program for causing a computer to function as each circuitry of the wireless communication apparatus according to claim 3.
